(19) United States
(12) Patent Application Publication
(10) Pub. No.: US 2021/0101413 A1
(43) Pub. Date: Apr. 8, 2021

(54) Tire Construction For Vehicle Towing

(71) Applicant: Polaris Industries Inc., Medina, MN (US)

(72) Inventors: Nathan Zeiter, Medina, MN (US); Stacey E. STEWART, Stillwater, MN (US)

(21) Appl. No.: 17/025,478

(22) Filed: Sep. 18, 2020

Related U.S. Application Data
(60) Provisional application No. 62/911,635, filed on Oct. 7, 2019.

(51) Int. Cl. B60C 11/03; B60C 1/00

(52) U.S. Cl. CPC B60C 11/0311; B60C 2200/14; B60C 1/0016

(57) ABSTRACT

A tire for positioning a vehicle on a surface includes a first sidewall, a second sidewall and a tread extending between the first sidewall and the second sidewall. The tread includes a first pavement bar and a first plurality of lugs disposed between the first sidewall and the first pavement bar and a second plurality of lugs disposed between the second sidewall and the first pavement bar. The tread includes a first lateral shape at a first inflation pressure so that the first pavement bar touches the surface without the first plurality of lugs or the second plurality of lugs contacting the surface. The tread comprises a second lateral shape at a second pressure less than the first pressure so that the first plurality of lugs, the first pavement bar and the second pavement bar contact the surface.

### CROSS-REFERENCE TO RELATED APPLICATION

This application claims the benefit of U.S. Provisional Application No. 62/911,635, filed on Oct. 7, 2019. The entire disclosure of the above application is (are) incorporated herein by reference.

### FIELD

The present disclosure relates to a tire construction and, more particularly, to a tire construction for a towed vehicle.

### BACKGROUND

This section provides background information related to the present disclosure which is not necessarily prior art.

Off-road vehicles are increasing in popularity. Most people do not live adjacent to an off-road trail. Therefore, the off-road vehicle must be transported to a location for riding. Typically off-road vehicles are loaded onto a trailer and moved to the desired location for riding. When not in use, the trailer and the off-road vehicle must be stored. This places a burden on the off-road vehicle owner. Another way to move the off-road vehicle to a desired location is by towing. One problem with towing is that the tires for an off-road vehicle wear out more rapidly, especially on pavement. One way to compensate for this is to provide a separate set of tires for the off-road vehicle. The separate set of tires are typically provided on a separate set of wheels. The separate set of tires are appropriate for pavement and do not exhibit the wear of off-road tires. However, the added expense, labor, and inconvenience associated with changing the tires at the location is not desirable.

### SUMMARY

This section provides a general summary of the disclosures, and is not a comprehensive disclosure of its full scope or all of its features.

A tire construction suitable for towing a vehicle to minimize wear to the off-road characteristics of the tire are set forth.

In one aspect of the disclosure, a tire for positioning a vehicle on a surface includes a first sidewall, a second sidewall and a tread extending between the first sidewall and the second sidewall. The tread includes a first pavement bar and a first plurality of lugs disposed between the first sidewall and the first pavement bar and a second plurality of lugs disposed between the second sidewall and the first pavement bar. The tread includes a first lateral shape at a first inflation pressure so that the first pavement bar touches the surface without the first plurality of lugs or the second plurality of lugs contacting the surface. The tread comprises a second lateral shape at a second pressure less than the first pressure so that the first plurality of lugs, the first pavement bar and the second pavement bar contact the surface.

Further areas of applicability will become apparent from the description provided herein. The description and specific examples in this summary are intended for purposes of illustration only and are not intended to limit the scope of the present disclosure.

### DRAWINGS

FIG. 1 is a side view of an off-road vehicle being towed by a tow vehicle.

FIG. 2A is a simplified cross sectional view of an off-road tire.

FIG. 2B is a second example of an off-road tire.

FIG. 3 is a simplified cross sectional view of the tire of FIG. 2A in a lower inflated state.

FIG. 4 is a front view of a tread pattern of a tire having a first bar.

FIG. 5 is a front view of a tread pattern of a tire having two bars.

FIG. 6 is a detailed cross sectional view of the tire of FIG. 2A.

### DETAILED DESCRIPTION

Examples will now be described more fully with reference to the accompanying drawings. Although the following description includes several examples of a utility vehicle application, it is understood that the features herein may be applied to any appropriate vehicle, such as motorcycles, all-terrain vehicles, moped, scooters, etc. The examples disclosed below are not intended to be exhaustive or to limit the disclosure to the precise forms disclosed in the following detailed description. Rather, the examples are chosen and described so that others skilled in the art may utilize their teachings.

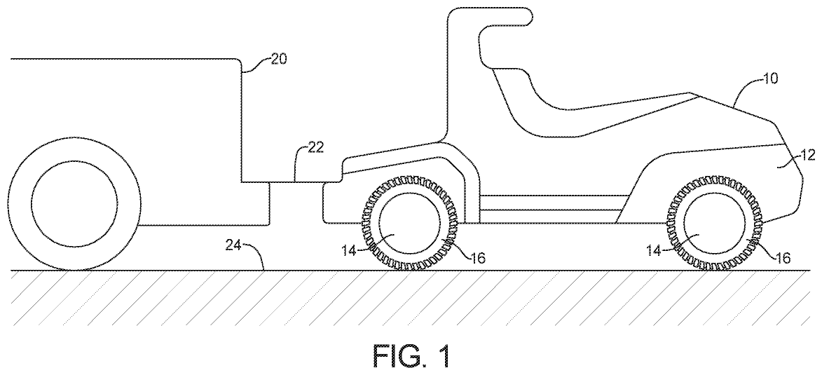

Referring now to FIG. 1, an off-road vehicle 10 is illustrated. The off-road vehicle 10 includes a vehicle body 12, wheels 14, and tires 16. The wheels 14 are coupled to the body 12 through a suspension (not shown).

A tow vehicle 20 may be used for towing the off-road vehicle 10 using a tow apparatus 22 such as a tow bar or one or more tow straps. In this example, the off-road vehicle 10 is towed with all four vehicles contacting the road surface 24. However, the tow apparatus 22 may include a wheel lift so that only two of the tires 16 contact the road surface 24.

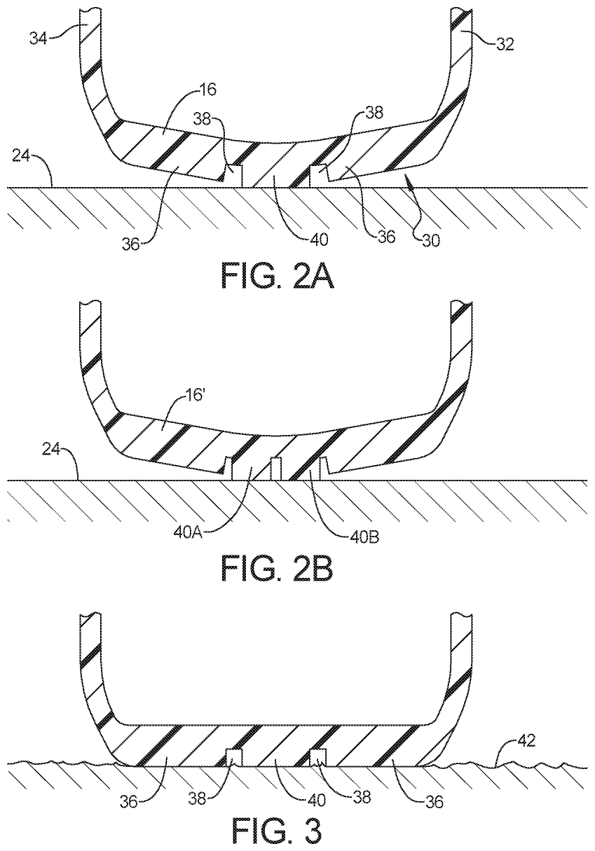

Referring now to FIG. 2A, the road surface 24 is illustrated relative to one of the tires 16. The tire 16 has a tread 30, a first sidewall 32, and a second sidewall 34. The tread 30 is illustrated having a plurality of lugs 36 with spaces 38 therebetween. The tread 30 also includes a center pavement bar 40. The center pavement bar 40 in this example is continuous and circumferential and is used to contact the road surface 24 during towing due to the lateral shape. The center pavement bar 40 may also be in a plurality of discontinuous center bar portions. During towing, the tire 16 is inflated to a first inflation pressure that is much higher than a second inflation pressure when using the vehicle on an off-road surface. As will be described in greater detail below, the center pavement bar 40 is formed from a material that is different than the material of the lugs 36. The center pavement bar 40 is more durable, more wear resistant and lasts longer than the material used to form the lugs 36. The construction of the tread 30 is described in further detail below. The lugs 36 are less wear resistant than the center pavement bar 40.

Referring now to FIG. 2B, the tread 30 may be comprised of a first center pavement bar 40A and second center pavement bar 40B each of which is circumferentially disposed around the center of the tire 16. When the tire is inflated to a high pressure, the lateral shape of the tread 30 allows the center pavement bars 40A and 40B contact the road surface 24.

Referring now to FIG. 3, in a lower pressure state than that illustrated in FIGS. 2A and 2B, the lateral shape of the tread 30 of the tire 16 allows the lugs 36 and the center pavement bar 40 to contact the off-road surface 42.

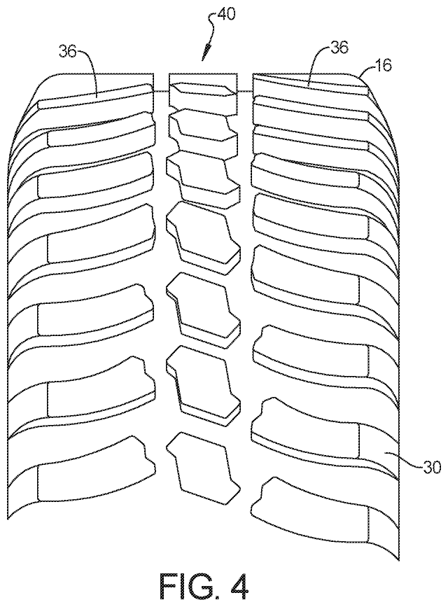

Referring now to FIG. 4, a front view of the tire 16 is illustrated. In this example, the tire 16 has the center pavement bar 40 and side lugs 36. The side lugs 36 are provided in two rows. The center pavement bar 40 is illustrated as a discontinuous tread pattern having a plurality of discontinuous center bar portions in the center of the tire 16.

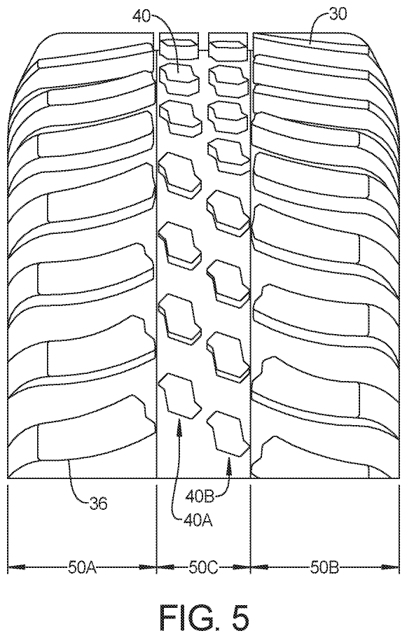

Referring now to FIG. 5, the tire 16′ illustrated in FIG. 2A is set forth. The tread surface 30 is illustrated having the two center pavement bars 40A, 40B that are discontinuous and each have a plurality of discontinuous center bar portions.

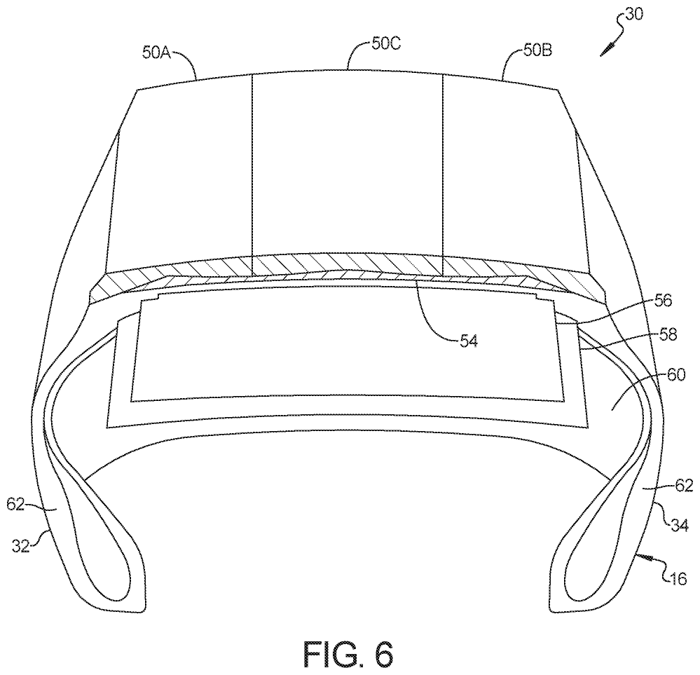

Referring now to FIG. 6, a cross section of the tire 16 is illustrated. In this example, three different compounds are used to form the tread. In this example compound A is in regions 50A and 50B directly adjacent to the respective sidewalls 32 and 34. Lugs 36 may be in the first region 50A and the second region 50B. A third region 50C disposed between regions 50A and 50B include the center pavement bar 40 or the center pavement bars 40A, 40B. The first region 50A and second region 50B may be formed of a first compound that has natural rubber (NR) greater than or equal to 90 parts per hundred rubber (PHR) and styrene-butadiene rubber (SBR) of less than 10 PHR. The filler system may be composed of carbon black and the cure system may be low sulfur content such as less than two PHR. The center or third region 50C has the center pavement bar 40 or bars 40A, 40B formed from a second compound. The second compound may be harder and offer greater tread wear than regions 50A, 50B. The third region 50C consists of a natural rubber (NR) and an SBR blend. For example, the center compound may be 50±15 PHR of natural rubber (NR) and 50±15 PHR of styrene-butadiene rubber (SBR). In this example, the filler system may also be carbon black and the cure system may also be low sulfur (less than 2 PHR).

The third material 54 that is disposed radially inward from the first region 50A, the second region 50B, and the third region 50C may consist of greater than 90 PHR of natural rubber (NR) and less than 10 PHR of styrene-butadiene rubber (SBR). The filler system may be carbon black, silica, or pre-coupled silica. The third material 54 may be referred to as an undertread. Under the undertread are an overwrap 56, a belt 58, a liner compound 60, and a body ply 62. More than one belt may be used. Also, in some configurations, the overwrap 56 may be eliminated. It should be noted that a belt or strips of nylon may be used to keep the shape of the tire and allow travel at higher speeds. Also, a thin layer of carbon black may be used between the lugs in the tire pattern and the space therebetween. This allows the tires to resist being electrostatically charged during operation.

In operation, during towing of the vehicle 10, the tires 16 of the vehicle are inflated to a relatively high pressure such as 26 pounds per square inch (PSI). The vehicle may be towed with the high tire pressure. When the tire pressure is high, the center pavement bar 40 or bars 40A, 40B contact the pavement. Because the center bar or bars have a high durometer, the center portion does not wear rapidly on the pavement (compared to the lugs adjacent thereto). When the vehicle is not being towed and the vehicle is to be driven off-road, the tire pressure is reduced to a substantially lower tire pressure such as 12 PSI. Of course, the high tire inflation pressure and the low tire inflation pressure may vary due to the configuration of the tire and the construction of the tread surface.

The foregoing description has been provided for purposes of illustration and description. It is not intended to be exhaustive or to limit the disclosure. Individual elements or features of a particular example are generally not limited to that particular example, but, where applicable, are interchangeable and can be used in a selected example, even if not specifically shown or described. The same may also be varied in many ways. Such variations are not to be regarded as a departure from the disclosure, and all such modifications are intended to be included within the scope of the disclosure.

What is claimed is:

1. A tire for positioning a vehicle on a surface comprising:
a first sidewall;
a second sidewall; and
a tread extending between the first sidewall and the second sidewall, said tread comprising a first pavement bar and a first plurality of lugs disposed between the first sidewall and the first pavement bar and a second plurality of lugs disposed between the second sidewall and the first pavement bar, said tread comprising a first lateral shape at a first inflation pressure so that the first pavement bar touches the surface without the first plurality of lugs or the second plurality of lugs contacting the surface, said tread comprising a second lateral shape at a second pressure less than the first inflation pressure so that the first plurality of lugs, the first pavement bar and the second pavement bar contact the surface.

2. The tire as recited in claim 1 wherein the first pavement bar is discontinuous in a plurality of center bar portions.

3. The tire as recited in claim 1 wherein the first pavement bar comprises a first compound and the first plurality of lugs comprises a second compound, different than the first compound.

4. The tire as recited in claim 3 wherein the first compound is harder than the second compound.

5. The tire as recited in claim 4 wherein the first compound is silica-free.

6. The tire as recited in claim 4 wherein the first compound comprises a natural rubber and styrene-butadiene rubber blend.

7. The tire as recited in claim 6 wherein the first compound comprises between about 35 and 65 parts per hundred natural rubber and between about 35 and about 65 parts per hundred styrene-butadiene rubber.

8. The tire of claim 7 further comprising a third region extending under the first plurality of lugs, the second plurality of lugs, and the first pavement bar.

9. The tire of claim 8 wherein the third region comprises greater than about 90 parts per hundred natural rubber and less than about 10 parts per hundred rubber styrene-butadiene rubber.

10. The tire of claim 9 wherein the third region comprises silica, carbon black, or pre-coupled silica.

11. The tire of claim 7 wherein the first compound comprises carbon black.

12. The tire of claim 7 wherein the first compound comprises less than about 2 parts per hundred rubber of sulfur.

13. The tire as recited in claim 3 wherein the first compound is silica-free, the second compound is silica-free.

14. The tire as recited in claim 3 wherein the first compound has higher tread wear than the second compound.

15. The tire as recited in claim 3 wherein the first compound comprises styrene butadiene-based rubber and natural rubber blend and the second compound comprises natural rubber.

16. The tire as recited in claim 1 wherein the tread comprising a second pavement bar.

17. The tire as recited in claim 16 wherein the second pavement bar comprises a plurality of discontinuous center bar portions.

18. The tire as recited in claim 16 wherein the second pavement disposed adjacent to the first pavement bar.

19. The tire as recited in claim 16 wherein the second pavement bar comprises a same material as the first pavement bar.

20. The tire as recited in claim 16 wherein the first plurality of lugs are disposed between the first sidewall and the first pavement bar and the second plurality of lugs are disposed between the second sidewall and the second pavement bar, and first pavement bar comprises a first compound and the second pavement bar comprises the first compound.
